(19) United States
(12) Patent Application Publication
(10) Pub. No.: US 2014/0279587 A1
(43) Pub. Date: Sep. 18, 2014

(54) SYSTEM FOR TRACKING VEHICLE SPEED VIOLATIONS

(71) Applicant: Thomas E. Gafford, Fort Worth, TX (US)

(72) Inventor: Thomas E. Gafford, Fort Worth, TX (US)

(73) Assignees: GapCorp FNI FZ LLC, Dubai Media City (AE); GPSI, LLC, Madison Heights, MI (US)

(21) Appl. No.: 13/799,925

(22) Filed: Mar. 13, 2013

(51) Int. Cl. G06Q 50/18; G06Q 10/10

(52) U.S. Cl. CPC G06Q 50/18; G06Q 10/10
USPC 705/311

(57) ABSTRACT

A system for detecting vehicle speed violations is disclosed. The system takes advantage of a vehicle's on-board equipment to track the vehicle speed and position. The speed of the vehicle can be determined in one of two ways. For example, the vehicle speed can be determined by measuring the distance between two points traveled by the vehicle and the time it took the vehicle to travel between the two points. This method relies on a vehicle GPS system and determines the speed of the vehicle by dividing the distance by the time. These GPS co-ordinates are sent to a central database by way of the vehicle on-board computer system and cellular phone system along with a vehicle ID and the date and time. Alternatively, the system can rely on the on-board vehicle speed sensor to transmit the vehicle speed and GPS coordinates along with the vehicle ID, date and time to a central database by way of the vehicle on-board computer and cellular phone system. The vehicle speed and location is system compared with posted speed limits by road segments. If the vehicle is found to be exceeding a posted speed limit, a central server prepares a citation and issues it to the vehicle owner.

### BACKGROUND OF THE INVENTION

1. Field of the Invention

The present invention relates to a system for tracking vehicle speed violations and more particularly a system for tracking the speed of a vehicle and comparing it with posted speed limits and automatically issuing speeding citations if the vehicle speed exceeds the posted speed limits.

2. Description of the Prior Art

Various systems are known for monitoring data related to the operation of motor vehicles. Examples of such systems are disclosed in U.S. Pat. Nos. 6,690,294; 7,595,741; 7,801,512; 7,893,846; 8,022,845; 8,189,048; and 8,344,909. Systems for monitoring data related to the operation of motor vehicles are also disclosed in US Patent Application Publication Nos.: US 2007/0316521 A1 and US 2013/0033386 A1.

US Patent Application Publication No. US 2013/0033386 A1 and U.S. Pat. No. 8,022,845 disclose an in-vehicle system which transmits the vehicle ID and vehicle position to a centralized database by way of a wireless communications link. The database is used to maintain various types of data related to vehicles, such as, insurance law compliance, motor vehicle registration and licensing compliance, traffic citations and other data on a vehicle by vehicle basis. Police vehicles with on-board computer systems are configured to check in with the database in order to pursue nearby vehicles that are identified by the database as being associated with violations or compliance failures.

A system, such as disclosed in the '386 application and '845 patent, is impractical since the database could likely only be maintained on a local level, for example, a municipal level considering local municipal ordinances requiring city stickers, etc. As such, many vehicles from outside the municipality would be immune to detection outside of their municipality.

Various other systems are known that track the speed of a vehicle and inform the driver of the motor vehicle whether the speed limit is being exceeded. Examples of these systems are disclosed in U.S. Pat. No. 7,595,741 and US Patent Application Publication No. US 2007/0216521 A1. The '741 patent discloses a system that includes an on-board database for storing traffic rules by geographic location. The system uses the vehicle GPS coordinates to determine traffic rules, for example, speed limits, in the locale of the vehicle. This information is compared with the current speed to indicate whether the vehicle speed is above the speed limit. If so, the driver is informed. The '521 publication relates to a system for assessing the probability that a driver of a vehicle will receive a traffic citation. The system uses real time vehicle speed data and various databases including a historical citation database and determines a probability of the driver of the vehicle a citation based upon the current speed and location of the vehicle and the historical data. Unfortunately, the systems disclosed in the '741 patent or '521 publication simply provide warnings to the drivers of the vehicles, which the drivers are free to ignore.

U.S. Pat. Nos. 6,690,294; 7,893,846; 8,189,048 and 8,344,909 disclose various systems for detecting and reporting vehicle speed violations utilizing cameras to detect the vehicle speed. Unfortunately, such systems only have limited utility since the cameras can only be located in a limited number of locations. Also, such camera based systems require a relatively large capital outlay by the municipality in which they are located.

In order to solve this problem, vehicle speed detection systems have been developed based upon relative locations of a cell phone located within the vehicle. Essentially, the system polls the cell towers and records the time that the cell phone checked in with the cell tower. Knowing the distance between cell towers, the system can determine the speed of a vehicle. Such a system can only determine the average speed of a vehicle and not the actual speed. For example, if a vehicle travels 30 miles per hour over the speed limit and then stops at rest stop, for example, such a system will not record a speed limit violation. In addition, the density of cell towers varies around the country. In general, there are fewer cell towers in rural areas rendering such a system virtually useless in some areas.

Thus, there is a need for a system for detecting vehicle speed violations relatively accurately and inexpensively so that a citation can be issued to the offender.

### SUMMARY OF THE INVENTION

Briefly, the present invention relates to a system for detecting vehicle speed violations. The system takes advantage of a vehicle's on-board equipment to track the vehicle speed and position. The speed of the vehicle can be determined in one of two ways. For example, the vehicle speed can be determined by measuring the distance between two points traveled by the vehicle and the time it took the vehicle to travel between the two points. This method relies on a vehicle GPS system and determines the speed of the vehicle by dividing the distance by the time. These GPS co-ordinates are sent to a central database by way of the vehicle on-board computer system and cellular phone system along with a vehicle ID and the date and time. Alternatively, the system can rely on the on-board vehicle speed sensor to transmit the vehicle speed and GPS coordinates along with the vehicle ID, date and time to a central database by way of the vehicle on-board computer and cellular phone system. The vehicle speed and location is compared with posted speed limits by road segments. If the vehicle is found to be exceeding a posted speed limit, a central server prepares a citation and issues it to the vehicle owner.

### DESCRIPTION OF THE DRAWING

These and other advantages of the present invention will be readily understood with reference to the following specification and attached drawing wherein:

FIG. 1 is a data flow diagram of the system for detecting the speed of a vehicle and issuing citations.

### DETAILED DESCRIPTION

The present invention relates to a system for detecting vehicle speed violations. The system takes advantage of a vehicle's on-board equipment to track the vehicle speed and position. The speed of the vehicle can be determined in one of two ways. For example, the vehicle speed can be determined by measuring the distance between two points traveled by the vehicle and the time it took the vehicle to travel between the two points. This method relies on a vehicle GPS system and determines the speed of the vehicle by dividing the distance by the time. These GPS co-ordinates are sent to a central database by way of the vehicle on-board computer system and cellular phone system along with a vehicle ID and the date and time. Alternatively, the system can rely on the on-board vehicle speed sensor to transmit the vehicle speed and GPS coordinates along with the vehicle ID, date and time to a central database by way of the vehicle on-board computer and cellular phone system. The vehicle speed and location is compared with posted speed limits by road segments. If the vehicle is found to be exceeding a posted speed limit, a central server prepares a citation and issues it to the vehicle owner.

Referring first to FIG. 1, a data flow diagram of the system is illustrated. In one embodiment, as discussed below, the system relies on vehicle speed data commonly available in virtually all vehicles built in the US after 1996. More specifically, as is known in the art, such vehicles normally include certain on-board equipment, generally identified with the reference numeral 20. This equipment 20 normally includes a plurality of vehicle sensors, generally identified with the reference numeral 22, which includes a vehicle speed sensor 24 as well as other sensors 26, such as seat belt sensors. These sensors 22 are known to be fed to a vehicle on-board computer (OBD) 28, which processes the sensor inputs according to the vehicle manufacturer specifications. Various sensor inputs including vehicle speed are available at what is known as an OBD II data port 30 by way of a OBD II data port connector, normally under the dash or the hood of a vehicle.

In accordance with the present invention, additional on-board equipment, generally Identified with the reference numeral 32, is used to provide the vehicle speed, vehicle ID and the date and time to a central server 34 and database 36. The additional on-board equipment includes an OBD II port connector (not shown), connected to the vehicle OBD II port 30 connector. The additional on board equipment includes a CPU system, a GPS receiver 40, a cellular phone system 46 and an RFID 46.

In the first embodiment of the invention, the vehicle speed data is read by the CPU system 38 on a periodic basis, for example every 10 seconds. This data is stored with a time and data stamp. Similarly, GPS data is received by the GPS receiver and also stored by the CPU system with a time and date stamp. Vehicle ID number (VIN) or other number may be programmed into an RFID device. Vehicle speed data and GPS data for the same date and time intervals are sent to a wireless receiver 40 coupled to the central server 34 along with the vehicle ID by the cellular phone system or other wireless link.

Alternatively for vehicles without an OBD II port, the speed of the vehicle is calculated by the CPU system 38 by subtracting the distance between two GPS points defining a traveled distance and determining the time the vehicle took to travel between the two points. Since the data from the vehicle is time stamped, the time stamp at the first point is subtracted from the time stamp of the second GPS to come up with the time difference between the two data points. The traveled distance is divided by the time difference by the CPU system 38 to arrive at the vehicle speed. The vehicle speed is then transmitted over the wireless link to wireless receiver 40 the central server 34 in a similar manner as discussed above.

As mentioned above, the central server system, generally identified with the reference numeral 33, includes a central server 34, coupled to a wireless receiver 40 which receives data from the CPU system 38 on-board the vehicle by way of the cellular phone system or other wireless transmitter 42. The central server 34 is also coupled to a central database 36 in which it compares the information from the vehicle with data stored in the central database 36 to determine if a vehicle speed violation has occurred.

The central database 36 includes a listing of road segments and the posted speed limit for each segment. The central database 36 also includes demographic information for vehicle owners, such as name and address and the vehicle ID number (VIN). The demographic information of the owners including the VIN is available from the Department of Motor Vehicles for all states. The central database 36 also includes a rules engine which identifies the various speeding ordinances and violations as a function of the speed.

The vehicle GPS data, speed data, VIN and optionally the time and date is compared with data in the central database 36. Initially, the central server 34 checks the GPS coordinates received from the vehicle on board computer system 38 to determine the posted speed limit for the particular road segment identified by those GPS coordinates. The central server 34 then checks the vehicle speed against the posted speed limit for the particular road segment. If the vehicle is determined to be exceeding the posted speed limit, the central server 34 generates a citation specifying the actual speed of the vehicle, the posted speed limit and specific ordinance that was violated along with the road segment along with the date and time. The citation is issued to the vehicle owner as identified from the central database by the VIN number. The citation can be in the form of a post card ready to mail to the violator. Other forms of the citation are also contemplated.

Obviously, many modifications and variations of the present invention are possible in light of the above teachings. Thus, it is to be understood that, within the scope of the appended claims, the invention may be practiced otherwise than as specifically described above.

What is claimed and desired to be secured by a Letters Patent of the United States is:

We claim:

1. A method for automatically determining if a vehicle is speeding and automatically issuing a speeding citation, the system comprising:
(a) determining locations traveled by a vehicle;
(b) determining the speed of the vehicle; and
(c) automatically issuing a citation to a vehicle owner for speeding.

2. The method as recited in claim 1, wherein step (a) comprises:
(a) determining locations traveled by a vehicle by way from the vehicle on-board vehicle speed sensors.

3. The method as recited in claim 1, wherein step (a) comprises:
(a) determining locations traveled by a vehicle by computing the distance between at least two GPS locations and the time difference between those locations.

4. A system for tracking vehicle speed violations configured to receive vehicle speed and location information from vehicles, the system comprising:
vehicle on-board equipment for determining the speed and location of a vehicle and transmitting over a wireless link; the vehicle speed, location and vehicle ID number (VIN) to a central server; and
a central server system for receiving said vehicle speed, location and said VIN over said wireless link and determining if said vehicle is in violation of any speed limits and generating a citation if said vehicle is determined to be in violation of a speed limit.

5. The system as recited in claim 4, wherein said vehicle on board system includes an RFID for storing the vehicle VIN.

6. The system as recited in claim 4, wherein said vehicle on-board equipment includes a GPS receiver, a CPU system and a wireless system for transmitting the vehicle speed, location and vehicle ID number (VIN).

7. The system as recited in claim 6, further including an OBD II data port for receiving the vehicle speed signal from the vehicle on-board computer.

8. The system as recited in claim 6, wherein said CPU system calculates the speed of the vehicle based upon GPS locations.

9. The system as recited in claim 4, wherein said wireless link is a cellular phone system.

10. The system as recited in claim 4, wherein said citation is in the form of a post card.
